(19) United States
(12) Patent Application Publication
(10) Pub. No.: US 2013/0043793 A1
(43) Pub. Date: Feb. 21, 2013

(54) LIGHTNING-PROOF AC LED DRIVING DEVICE

(71) Applicant: Cheng-Hung PAN, Taipei (TW)

(72) Inventor: Cheng-Hung PAN, Taipei (TW)

(73) Assignee: LUXUL TECHNOLOGY INCORPORATION

(21) Appl. No.: 13/564,140

(22) Filed: Aug. 1, 2012

(30) Foreign Application Priority Data
Aug. 18, 2011 (TW) 100129488

(51) Int. Cl. H05B 37/02

(52) U.S. Cl. 315/127

(57) ABSTRACT

A lightning-proof AC LED driving device has a lightning detector breaker connected between a rectifier and an AC LED driver circuit. When lightning strikes, a high voltage enters the rectifier, and the anode and cathode of the rectifier are equipotential, making the lightning detection breaker automatically disconnect the AC LED driver circuit from the rectifier. This interrupts the connection between the rectifier and the AC LED driver circuit. Thus, the AC LED driving device has the lightning-proof function.

### BACKGROUND OF THE INVENTION

1. Field of the Invention

The invention relates to a lightning-proof AC LED driving device and, in particular, to a lightning-proof AC LED driving device that uses the lightning detection breaker to prevent lightning strikes.

2. Description of Related Art

A general power line may be as short as hundreds of meters or as long as several kilometers. Under a lightning strike, the power line will produce a high voltage of up to several thousand volts. If such a high voltage goes through the power line and enters buildings, it is easy to damage electrical appliances connected to the power line.

A conventional arrester uses two discharge ends and an air gap as protection. The two discharge ends connect respectively to a power line and a ground point. When the lightning produces a voltage greater than an air-gap discharge voltage, there is a discharge from one discharge end through the air gap to the other discharge end connected to the ground point. The above-mentioned arrester can also use an isolation transformer for lightning isolation. The high voltage due to lightning is isolated on the primary side of the isolation transformer, preventing the circuit on the secondary side of the isolation transformer from being damaged by the lightning occurring on the primary side.

When the arrester is struck by lightning, the high voltage through the arrester will produce heat. Moreover, the isolation transformer is bulky. When the isolation transformer is connected to AC power, the arrester produces heat due to the impedance of its internal circuit. For LED lamps used in a limited space, heat dissipation and the size problems all pose a challenge in circuit designs and circuit board layouts.

As described above, the conventional arrester has problems of large size and poor heat dissipation. Therefore, when the LED lamp is equipped with an arrester, there is a lot of difficulty in the circuit design thereof.

### SUMMARY OF THE INVENTION

An objective of the invention is to provide a lightning-proof AC LED driving device without using a transformer.

To achieve the above-mentioned objective, the lightning-proof LED driving device includes:

a rectifier for converting an AC sine wave power supply to a DC power and outputting the DC power through an anode and a cathode;

an AC LED driver circuit with the rectifier connected to a base and electrically connected to the anode and cathode of the rectifier; and

a lightning detection breaker connected in series between the rectifier and the AC LED driver circuit and electrically connected to the base to determine the potentials at the anode and cathode of the rectifier, wherein the lightning detection breaker automatically conducts when the potentials are different, and disconnects the AC LED driver circuit from the rectifier when the potentials thereof are the same.

When a high voltage caused from the lightning strike enters the rectifier, the anode and cathode of the rectifier are equipotential, leaving the lightning detection breaker connected between the rectifier and the AC LED driver circuit automatically become an open-short circuit, thereby interrupting the path through which the high voltage may pass to the AC LED driver circuit. The AC LED driver circuit is thus protected from the lightning strike.

### BRIEF DESCRIPTION OF THE DRAWINGS

FIG. 1 is a circuit block diagram of the invention;

FIG. 2 is a detailed circuit diagram showing the connection between the lightning detection breaker and both the rectifier and the AC LED driver circuit of the invention;

FIG. 3 is a circuit diagram showing the lightning-proof AC LED driving device of the invention without encountering a lightning strike;

FIG. 4 is a circuit diagram showing the lightning-proof AC LED driving device of the invention encountering a lightning strike when there is an AC power;

FIG. 5 is a circuit diagram showing the lightning-proof AC LED driving device of the invention encountering a lightning strike when there is no AC power; and

FIG. 6 is a circuit diagram of an optical coupler according to the preferred embodiment.

### DETAILED DESCRIPTION OF THE PREFERRED EMBODIMENT

With reference to FIG. 1, the invention includes a rectifier 10, an AC LED driver circuit 30 connected to the rectifier 10, and a lightning detection breaker 20 connected in series between the rectifier 10 and the AC LED driver circuit 30. The AC LED driver circuit 30 and the rectifier 10 are disposed on a same base 35. When normal AC power enters the rectifier 10, an anode and a cathode of the rectifier 10 have different potential levels, so that the lightning detection breaker 20 automatically shorts the circuit, so that the rectifier 10 is connected to the AC LED driver circuit 30. When a lightning strike produces a high voltage that enters the rectifier 10 via AC power, the anode and cathode of the rectifier will become equipotential, inducing the lightning detection breaker 20 to automatically disconnect the circuit, thereby cutting off the path through which the high voltage enters the AC LED driver circuit 30. Therefore, the high voltage will not damage the AC LED driver circuit 30.

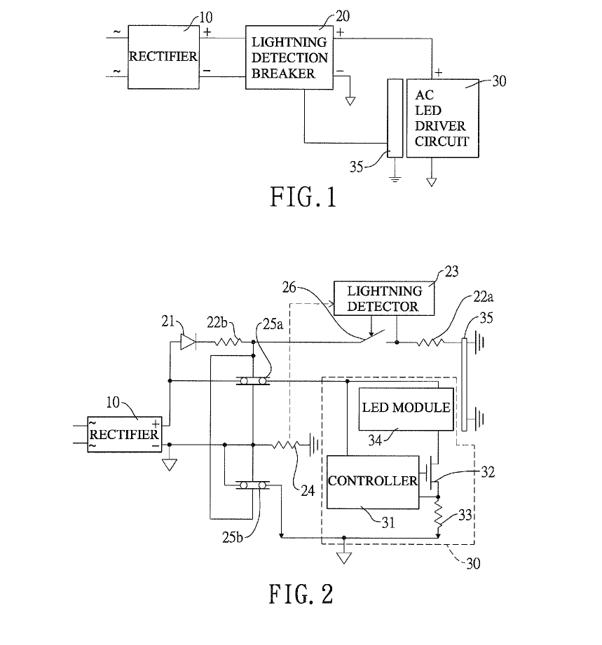

With reference to FIG. 2, the lightning detection breaker 20 further includes a detection resistor 24, a lightning detector 23, a switch 26, a first differential pressure switch unit 25a, and a second differential pressure switch unit 25b.

The rectifier 10 converts AC sine wave power into DC power. The cathode of the rectifier 10 is connected to a ground point. In this embodiment, the rectifier 10 is a full-wave rectifier.

The AC LED driver circuit 30 has two power supply terminals connected to the anode and the cathode of the rectifier 10, respectively. In this embodiment, the AC LED driver circuit 30 includes a controller 31, a voltage-controlled transistor 32, a current detector 33 and an LED module 34. The controller 31 according to the signal of the current detector 33 turns on or off the voltage-controlled transistor 32. This controls the current of the LED module 34 to be a constant current, stabilizing the illumination of the LED module 34.

One end of the detection resistor 24 is connected to the cathode of the rectifier 10, and the other end is connected to the base 35 of the AC LED driver circuit 30, i.e. the ground.

The lightning detector 23 has two detection terminals and an output terminal. The two detection terminals are connected in series between the detection resistor 24 and the base 35 of the AC LED driver circuit 30. With reference to FIG. 6, in this embodiment, the lightning detector 23 includes an optical coupler 27. Both ends of an LED of the optical coupler 27 are connected to two input terminals of the lightning detector 23. An output terminal of the optical coupler 27 is connected to the output terminal of the lightning detector 23. Moreover, a resistor 28 is connected to the output terminal of the optical coupler 27. When there is a voltage on the detection resistor 24, the optical coupler 27 turns on, and a voltage is generated on both ends of the resistor 28.

The switch 26 has two contacts and a control end by which the two contacts are controlled to open or close. In this embodiment, the switch 26 is a voltage-controlled transistor having a source terminal, a gate terminal and a drain terminal. One of the contacts is the source terminal, connected in series with a resistor 22a to the base 35. The other contact is the drain terminal, connected in series with a resistor 22b and a diode 21 and then to the anode of the rectifier 10. The control end is the gate terminal, connected to the output of the lightning detector 23. The lightning detector 23 controls the contacts of the voltage-controlled transistor to open or close. That is, when both ends of the resistor 28 produce a voltage, the two contacts of the voltage-controlled transistor are connected, i.e. the switch 26 is turned on.

The first differential pressure switch unit 25a has two control ends and two contacts. The first control ends is connected to the cathode of the rectifier 10 and one end of the detection resistor 24. The second control end is connected to the switch 26. The two contacts of the first differential pressure switch unit 25a are respectively connected to the anode of the rectifier 10 and one of the power supply sides of the AC LED driver circuit 30. When the two control ends of the first differential pressure switch unit 25a have different potentials, the two contacts of the first differential pressure switch unit 25a are automatically short-circuited. When the two control ends of the first differential pressure switch unit 25 have the same potential, the two contacts automatically disconnect.

The second differential pressure switch unit 25b has two control ends and two contacts. The first control ends is connected to the cathode of the rectifier 10 and one end of the detection resistor 24. The second control end is connected to the switch 26. The two contacts are respectively connected to the cathode of the rectifier 10 and the other power supply terminal of the AC LED driver circuit 30. When the two control ends have different potentials, the two contacts are automatically short-circuited. When the two control ends have the same potential, the two contacts automatically disconnect.

When normal AC power enters the rectifier 10, the cathode of the rectifier 10 is connected via the detection resistor 24 to the base 35. Since the base 35 and the cathode of the rectifier 10 are equipotential at the ground point, the lightning detector 23 is not triggered, keeping the switch 26 open. The two control ends of the first differential pressure switch unit 25a and the second differential pressure switch unit 25a are connected respectively to the anode and cathode of the rectifier 10. When the two control ends have different potentials, the two differential pressure switch units 25a, 25b are closed. The DC power from the DC rectifier 10 is passed to the two power supply terminals of the AC LED driver circuit 30, so that the LED module 34 therein can illuminate stably.

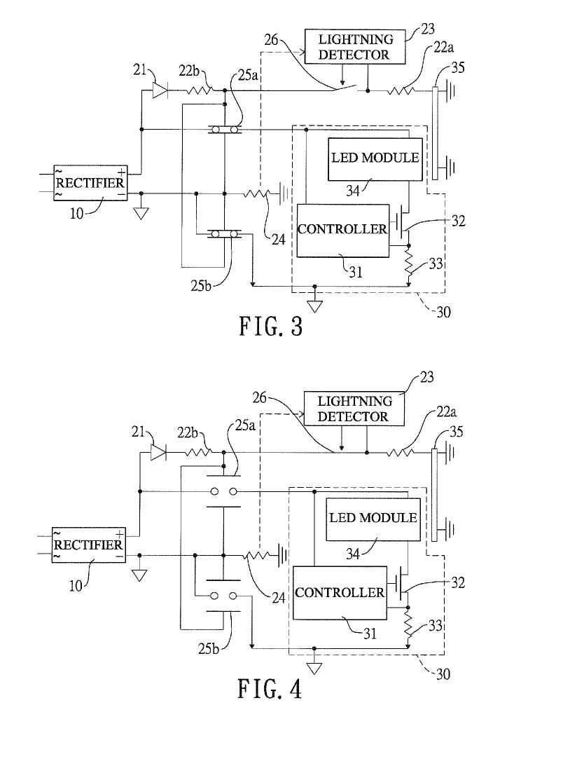

With reference to FIGS. 3 and 6, when a lightning strike produces high voltage entering the rectifier 10, the anode and cathode of the rectifier 10 simultaneously have the high voltage. When the cathode of the rectifier 10 outputs the high voltage via the detection resistor 24 to the base 35, the two ends of the detection resistor 24 generate a voltage. The voltage potential makes the optical coupler 27 of the lightning detector 23 conductive. A voltage is generated across the resistor 28 connected to the output terminal of the optical coupler 27, which turns on the switch 26 connected to the output terminal of the lightning detector 23. With reference to FIG. 4, the high voltage output from the anode of the rectifier 10 goes through the diode 21, resistor 22b, a short-circuited switch 26 and resistor 22a to the base 35, thereby forming a loop. The resistor 22b and resistor 22a form a voltage divider, so that the voltage potentials generated on the resistor 22a and on the detection resistor 24 are equal. The equal voltage potentials break the two contacts of the first differential pressure switch unit 25a and the second differential pressure switch unit 25b, cutting off the path through which the high voltage enters the AC LED driver circuit 30. This achieves the function of avoiding lightning strikes to the circuit.

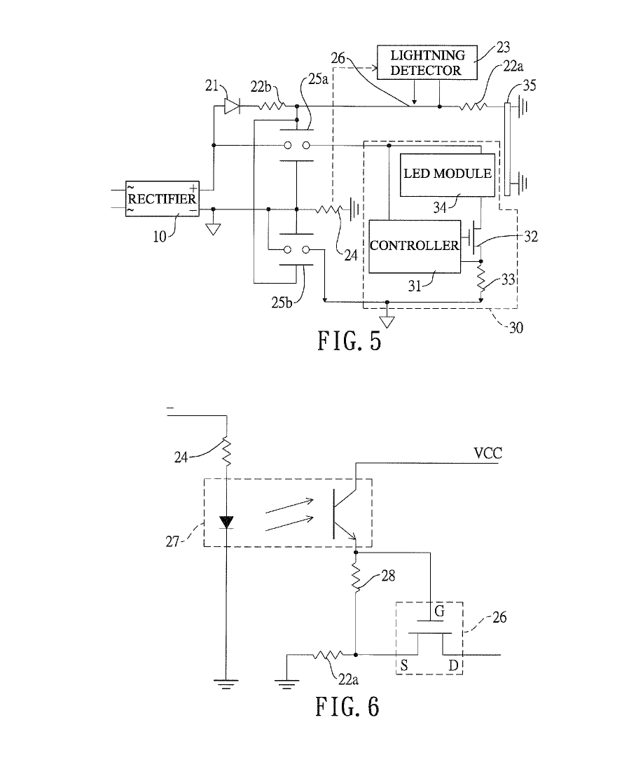

With reference to FIG. 5, when there is no AC power but a lightning strike occurs, the high voltage generates a potential difference between the two ends of the detection resistor 24. The lightning detector 23 short-circuits the switch 26, so that the voltage potentials on the resistor 22a are the same as that on the detection resistor 24. The two control ends of the first differential potential switch unit 25a and the second differential potential switch unit 25b are equipotential. The two differential potential switch units 25a and 25b are turned off. This prevents the high voltage from entering the AC LED driver circuit 30.

In summary, the invention can prevent lightning strikes from damaging the AC LED driver circuit without using a large transformer. Whether the AC LED driver circuit is functioning, the high voltage produced by the lightning strike can always be prevented from entering the AC LED driver circuit, achieving the lightning-proof function.

What is claimed is:

1. A lightning-proof AC LED driving device, comprising:
a rectifier for converting an AC sine wave power supply to a DC power and outputting the DC power through an anode and a cathode;
an AC LED driver circuit with the rectifier connected to a base and electrically connected to the anode and cathode of the rectifier; and
a lightning detection breaker connected in series between the rectifier and the AC LED driver circuit and electrically connected to the base to determine the potentials at the anode and cathode of the rectifier, wherein the lightning detection breaker automatically conducts when the potentials are different and disconnects the AC LED driver circuit from the rectifier when the potentials thereof are the same.

2. The lightning-proof AC LED driving device as claimed in claim 1, wherein the lightning detection breaker comprises:
a detection resistor having a first end connected to the cathode of the rectifier and a second end connected to the base of the AC LED driver circuit, wherein the base is connected to a ground;
a lightning detector having two detection terminals and one output terminal, with the two detection terminals respectively connected to the detection resistor and the base of the AC LED driver circuit;
a switch having:
a first contact connected to the base of the AC LED driver circuit through a first resistor;
a second contact connected to the anode of the rectifier through a second resistor and a diode; and
a control end connected to the output terminal of the lightning detector so that the lightning detector controls the connection of the two contacts of the switch;
a first differential potential switch unit having:
a first control end connected to the cathode of the rectifier and the detection detector;
a second control end connected to the second contact of the switch;
two contacts respectively connected to the anode of the rectifier and the AC LED driver circuit, wherein the two contacts form a short-circuit when the potentials at the first control end and the second control end are different and form an open-circuit when the potentials at the first control end and the second control end are the same; and
a second differential potential switch unit having:
a first control end connected to the cathode of the rectifier and the detection detector;
a second control end connected to the second contact of the switch; and
two contacts respectively connected to the cathode of the rectifier and the AC LED driver circuit, wherein the two contacts form a short-circuit when the potentials at the first control end and the second control end of the second differential potential switch unit are different, and form an open-circuit when the potentials at the first control end and the second control end of the second differential potential switch unit are the same.

3. The lightning-proof AC LED driving device as claimed in claim 2, wherein the lightning detector includes an optical coupler and a resistor.

4. The lightning-proof AC LED driving device as claimed in claim 2, wherein the switch is a voltage-controlled transistor.

5. The lightning-proof AC LED driving device as claimed in claim 3, wherein the switch is a voltage-controlled transistor.

6. The lightning-proof AC LED driving device as claimed in claim 1, wherein the rectifier is a full-wave rectifier.

7. The lightning-proof AC LED driving device as claimed in claim 2, wherein the rectifier is a full-wave rectifier.

8. The lightning-proof AC LED driving device as claimed in claim 3, wherein the rectifier is a full-wave rectifier.

9. The lightning-proof AC LED driving device as claimed in claim 4, wherein the rectifier is a full-wave rectifier.

10. The lightning-proof AC LED driving device as claimed in claim 5, wherein the rectifier is a full-wave rectifier.

11. The lightning-proof AC LED driving device as claimed in claim 4, wherein the pressure-controller transistor is a metal oxide semiconductor field effect transistor having a source terminal, a drain terminal and a gate terminal, the source terminal is connected to the base of the AC LED driver circuit through the first resistor, the drain terminal is connected through the second resistor and the diode to the anode of the rectifier, and the gate is terminal of the control end.

12. The lightning-proof AC LED driving device as claimed in claim 5, wherein the pressure-controller transistor is a metal oxide semiconductor field effect transistor having a source terminal, a drain terminal and a gate terminal, the source terminal is connected to the base of the AC LED driver circuit through the first resistor, the drain terminal is connected through the second resistor and the diode to the anode of the rectifier, and the gate is terminal of the control end.

13. The lightning-proof AC LED driving device as claimed in claim 9, wherein the pressure-controller transistor is a metal oxide semiconductor field effect transistor having a source terminal, a drain terminal and a gate terminal, the source terminal is connected to the base of the AC LED driver circuit through the first resistor, the drain terminal is connected through the second resistor and the diode to the anode of the rectifier, and the gate is terminal of the control end.

14. The lightning-proof AC LED driving device as claimed in claim 10, wherein the pressure-controller transistor is a metal oxide semiconductor field effect transistor having a source terminal, a drain terminal and a gate terminal, the source terminal is connected to the base of the AC LED driver circuit through the first resistor, the drain terminal is connected through the second resistor and the diode to the anode of the rectifier, and the gate is terminal of the control end.
